(19) United States
(12) Patent Application Publication
(10) Pub. No.: US 2005/0099620 A1
(43) Pub. Date: May 12, 2005

(54) Process and plant for quality control inspection of bakery products

(76) Inventors: Angel De La Ballina, Villefranche de Rouergue (FR); Helios De La Ballina, Maleville (FR); Pierre Robert, Cholet (FR); Olivier Somville, Meulaine sur Aubance (FR)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/956,360

(22) Filed: Oct. 4, 2004

(30) Foreign Application Priority Data
Oct. 3, 2003 (FR) 0311649

(51) Int. Cl. G01N 21/88

(52) U.S. Cl. 356/237.1

(57) ABSTRACT

In accordance with the invention, the products to be inspected are made to travel past the field of vision of a matrix camera (4) which captures successive images when the products are lit alternately in direct lighting mode (32, 32) and in backlighting mode (33) through a translucent conveyor belt (35). With the help of the images obtained under backlighting, a contour inside which is defined a sample zone covering a surface of predetermined shape calculated so as to be intruded fully within the area of said contour is determined for each product. The contrasts discernible in surface analysis on the direct lighting image are then examined, for example to determined a density of blemishes.

The present invention relates to quality control inspection techniques involving capturing digital images and processing the signals obtained by image analysis considering said techniques as they may be applied in the industrial sector of baking. It is self evident that one is speaking here of the baking industry in the sense in which it is not limited to the manufacture of bakery products actually constituting leaves of bread in everyday food and in which it extends, for example, to all products referred to more particularly as Viennese pastry or biscuits.

Within the framework of the present invention, what is considered to be peculiar to this industry (or similar industries) is that the products whose quality one seeks to check before they are packaged for dispatch to clients are small products, which are deposited in bulk on a conveyor on exiting a manufacturing installation. Stated otherwise, these products do not show up one by one on the transporter belt of the conveyor, they are not all oriented in the same manner even if they all exhibit the same unit shape, and even the long loaves do not necessarily arrive parallel to the direction of travel imposed by the conveyor. Added to these uncertainties, especially when one wishes to employ hardware that may itself give rise to industrial level commercialization by virtue of appropriate customization facilities, is the fact that the products to be inspected for quality, if not merely by simple checking of compliance with respect to predefined dimensional standards, may equally well be completely finished cooked products for final food consumption or products considered in an intermediate step of the manufacturing chain. By way of examples, in the second case one may be dealing with so-called precooked products, deep-frozen raw products, before or after the dough proofing step, any product passing from an upstream manufacturing step to a downstream manufacturing step, the latter representing the “client” whose prerequisites have to be taken into account for quality control.

To carry out quality control on products of this kind, the invention makes provision to proceed by visiometry. That is to say it applies techniques of digital image data acquisition and of processing of the signals carrying such information which are in themselves conventional. It follows that it will not be necessary to describe these techniques here in as far as they are known, providing that the features of their application in a context such as that of baking are correctly disclosed.

The invention finds expression in several ways, mainly within the terms of a process and within those of a plant designed for the implementation of this process. It is manifested essentially in the mode of capture by acquisition of the digital image data, in the analysis of the corresponding signals and in the instructions controlling the items of the hardware, which instructions are triggered automatically as a function of the result of this analysis.

The invention will now be more precisely defined and described in its main characteristics, which may be considered not only individually but also in, all their technically operative combinations.

In accordance with one of these features of the invention the products or articles are deposited, without prior organization, preferably simply spread out extended from an upstream feed conveyor designed for this purpose, tending to separate them from one another in the longitudinal conveying direction and/or in the transverse direction which is perpendicular thereto, onto an inspection conveyor which makes them travel past a visiometry system where the capture of the digital images occurs in a so-called acquisition step.

This visiometry system is equipped with all necessary means for image capture which is double for each product, so as to be sensitive to degrees of contrast between gray levels of two different orders of magnitude or more generally to contrasts of two different orders or kinds, with a first order of contrasts for the contour image and a second order of contrasts for the surface image. The analysis of the signals manifesting the images thus gathered is performed similarly in two steps, which follow one another in time at a tempo synchronized with the lighting conditions.

The results of the analysis serve to instruct the transfer of each product to one exit or another, after a time span which is calculated in synchronism with the speed of travel of the products ensured by the conveyor. It is supposed that the picture taking system is itself fixed, but of course, what is important is the relative displacement of the products with respect to the picture, taking system, and this relative displacement during the capture of the images could be taken on board in whole or part by the picture taking system.

The invention makes advantageous application of operative schemes and of means that are themselves known, in particular those that have been described in European patent EP 0 763 470 as regards the referencing of individual products or articles when they together enter the field of vision of a matrix camera undertaking the capture of repetitive images and as regards the counting of the articles with calculation of a supplement to be effected so as to group them into a predetermined number for packaging. The same patent describes a sorting system that can advantageously be used within the framework of the implementation of the invention, it being a so-called “comb” device, whose function is to retain those of the articles that might, arrive in excess number and to allow through those that are necessary as a supplement.

As secondary features, the invention makes provision to capture the successive images in a repetitive manner via, a single matrix camera, adjusted by itself or via the parameters of the conditions of processing of the associated signals, for suitable operation adapted alternately to one and the other of the two degrees of contrast of different orders of magnitude.

At each period of the repetitive succession, on a determined product, image capture is performed firstly while the products are lit under a backlighting mode, that is to say under backprojection lighting, advantageously through the transporter belt of the conveyor, which belt is made translucent for this purpose. The signals expressing the backprojection image thus acquired are subjected to a computer type processing based on the contrast due to the difference in luminosity between the lit background of the image and the contour of the product inside which the image pixels manifest a stronger opacity. The degree of contrast between the two gray levels is set to be significant. The analysis of the signals retains as contour pixel each pixel where this contrast is at least equal to a predetermined threshold value. A contour image of each product is thus obtained.

On this contour image of the first step, the system carries out measurements to verify whether the product meets predetermined dimensional geometry requirements by making sure that the dimensions in question are correctly situated inside ranges of predetermined values. In the favorable case, the product is assigned a compliant quality attribute, provided it complies also with requirements concerning the state surface, in the converse case, a noncompliance attribute.

As dimensional quality requirements are commonly encountered on the one hand the length, which is the distance between those of the points of the contour of the product which are furthest apart (whatever the orientation of the product), on the other hand the width, which is generally defined, at the simplest for baking applications, as being the distance between the extreme points of the contour on a straight line perpendicular to the length crossing the latter at its middle. Often added thereto is the sag, manifesting the curvature of the mid line of a product lengthwise, in particular by the distance from the middle of the width of the previous measurement to the straight line joining, the extreme points of the length. This sag will for example be that of a loaf of raw dough exiting a spiral-type freezer, in which case the quality requirements will demand that this sag not exceed a predetermined threshold.

Secondly, an image capture is carried out, performed in direct lighting mode, hence from above the product during transport on the conveying belt. A monochrome digital image is generally satisfactory for the needs of the preferred applications of the invention, although it is also possible to undertake colorimetry without however departing from the invention. However, it has been observed, under practical conditions of application, that it was in general both sufficient and more economical to undertake an analysis of the degrees of contrast between various gray levels. In such a case the contrasts of the second order for the surface state image differ from those of the first order assigned for the contour image in that the degree of contrast for the threshold is lower compared to the significant degree of contrast for the threshold value in the first step (contour image).

On the other hand, the gray levels to be distinguished are numerous and the sought-after accuracy is different from that to be chosen in the first step. In this instance it is a question of examining the surface state of each product considered in accordance with the variations in gray levels which become apparent inside the contour of the product determined during the first step A check is then carried out to verify whether predetermined surface state requirements are met so that the product is declared compliant.

In the preferred modes of implementation of the invention, the image data are used to determine whether blemishes manifested by degrees of contrast of predetermined value (or greater than a predetermined threshold value), as appropriate situated between gray levels in a predetermined range, are or are not present, and if so their density is calculated so as to compare it for example with a nominal density of presence of seeds (sesame or another type) imposed by the quality requirements.

To be able to calculate such a density or other similar item of information, the invention advantageously provides for a processing of the signals obtained with the help of the first image captured leading to the defining of the contour of a predetermined geometric shape whose dimensions are automatically adapted so that it is fully inscribed within the contour of the product image taken in the first step.

In preferred cases of practical application, having regard in particular to the frequency and to the nature of the shapes encountered in a manufacturing line for bakery products, the shape in question is that of an ellipse. The major diameter of the ellipse is advantageously calculated with the help of the length of the product, which will in general have been determined during the first step, if only to verify whether this length lies correctly inside a predetermined range (or close enough to a predetermined nominal value). Similarly, the minor diameter of the ellipse can be calculated with the help of the dimensional value that will have been attributable to the product in the guise of width in the first step.

Generally the two values will be reduced in a proportion of the same order of magnitude the one with regard to the other, so as to take account of ever possible uncertainties in the definition of the contour of the product. As appropriate, the system will also be able to take account of the value calculated in the guise of sag of the product in the case where the latter exhibits some curvature. Specifically, in all cases the ellipse contour retained shall not overstep the limits of the contour of the product.

In the preferred forms of implementation of the invention, the analysis of the signals manifesting the contrast images obtained in the second step leads to the determination of the density of presence of differences of contrast of determined values. In the simplest case, this density is determined over a single sample zone, which may for example be chosen in the middle of the ellipse in question above, or extend throughout its surface. In other cases of application, it may be preferable to define several sample zones, all situated inside the same contour inscribed entirely safely within the contour of the product, for example around each of the two centers of an elliptical contour.

Thus, by way of example, a check will be carried out to verify whether a quantity of sesame seeds which complies with the manufacturing prerequisites has been deposited on loaves. Likewise, a check may be carried out to verify whether the layout of the pixels wherein is revealed a difference in contrast of predetermined type does or does not correspond to that of an indentation, of lines or of marks of any type that the products ought to have. Through appropriate computer processing of the digital image data, resorting to techniques that are in themselves known in other industrial fields, it is possible to determine the extent to which two neighboring pixels revealing a given contrast difference pertain to one and the same line formed on the product, and then to define for example the orientation, the length, the width of such a line, and possibly to subsequently determine whether, for example, the lines retained as being significant are in a suitable orientation with respect to the general orientation of the particular product, whether there is a sufficient number of them, whether they are placed at correct distances apart.

Analysis of the contrasts, makes it possible to optically reveal the marks sought both in the case where they are due to a difference in the product's own coloration, for example as a function of the degree of cooking, and also when they are due to the surface geometry as a height variation. It is therefore understood that the system of the invention can be customized so as to discern thereby the presence of unacceptable cooking blemishes or that of deeper or shallower reliefs that will decide the compliance or otherwise of the product. In a general manner, a single rig may serve for almost all the situations encountered in baking provided that it is capable, for example, of a sensitivity distinguishing 255 gray levels.

In the practical implementation of the invention, there is provision for automatically steering the products toward distinct bins allocated to the compliant quality products and to noncompliant products as a function of the result of the analysis of the images. The sorting performed may take other criteria into consideration and undertake multiple steerings. In particular, in respect of bakery products, within the framework of the preferred conditions of application of the invention, it is particularly advantageous to undertake a detection of the possible presence of metallic elements in the products. Such detection is then advantageously performed upstream of the visiometry system.

In a conventional manner, this detection may be performed by magnetic means. Advantageously, a positive result of this detection automatically triggers, in the machine for implementing the invention, the instructing of a tilting flap that will divert the corresponding defective products into a special bin, reserved for severely polluted products, whereas, when noncompliance is deduced only after the visiometry operations proper, they will be directed toward a bin for defective products that are not however polluted by metallic elements.

In other variant implementations of the invention, a distinction may advantageously be made according to whether the products show up correctly individualized on exiting the quality control installation or, whether they show up grouped together as a mass of nonindividualized products. In the latter case, it may be advisable to instruct a more general dispatch of products to the bin for defective products so as not to retard the general processing rate. The situation is akin to that where the presence of a polluting element makes it preferable to dispatch all of those products that neighbor the one which caused the detection of pollution toward the products that are unfit for consumption.

As already indicated, the invention is also manifested by features pertaining to the hardware means designed to carry out the operations just set forth, hence in terms of a plant or of a machine particularly adapted to the implementation of the process of the invention.

Regarding the characteristics of the hardware means for implementing the invention, it may be emphasized that it is in general advantageous to instruct the backprojection lighting and the direct lighting via one and the same power supply circuit determining the operation of the one and the operation of, the other by determined successive flashes.

Moreover, provision is advantageously made for the rate of capture of the images to be determined in conjunction with the speed of travel of the products as imposed by the conveyor, but also in accordance with the requirements of the computer processing of the signals at each image taken, in order for the presence of each product to be manifested in a meaningful manner in at least three successive images. It is thus certain that in at least one of these three images, the product in question will be fully included in the field of vision of the camera capturing the instantaneous image.

The embodiment of the, hardware means for implementing the invention emerges more clearly from the figures supplementing this description, among which figures:

FIG. 1 diagrammatically illustrates the plant described during operation,

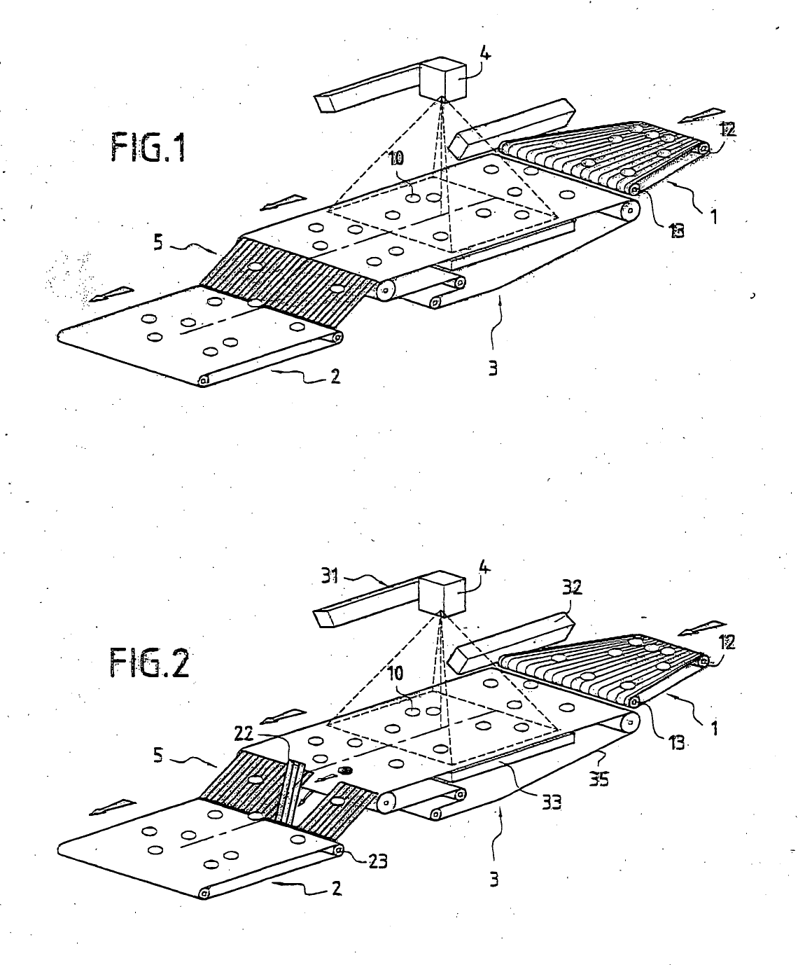

FIG. 2, still in a very diagrammatic form, shows how the exit distributor operates in the case where the presence of a defective product has been discerned,

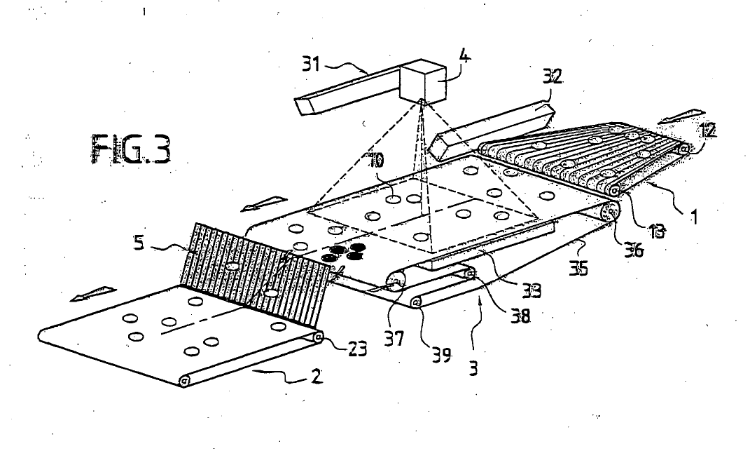

FIG. 3 illustrates in a similar manner the discharging of a mass of products,

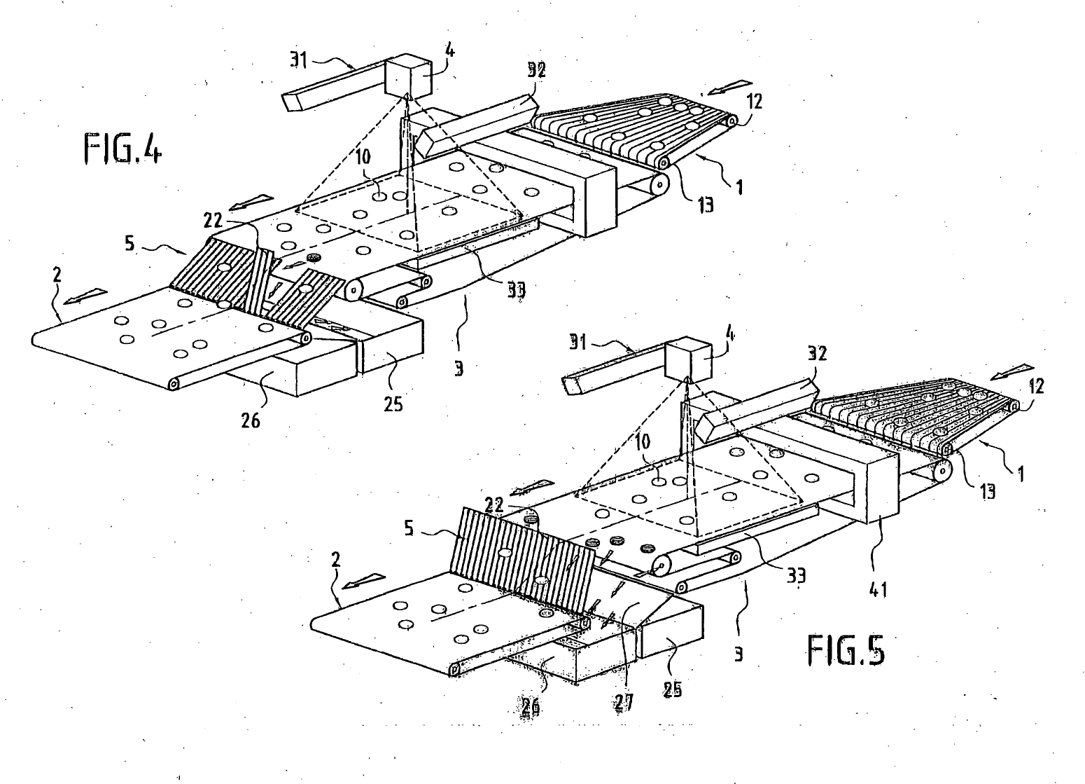

FIG. 4 diagrammatically presents the same, plant supplemented so as to ensure detection of products polluted by metallic elements,

FIG. 5 diagrammatically represents the same plant for a different position of a flap instructed as a function of the presence or otherwise of metallic elements in polluted products.

In these various figures, the representation of the machine according to the invention is confined to the essential principles of construction and of operation of the various items, in their mutual relations. It did not seem necessary to complicate the figures with the details of a mechanical embodiment which are in themselves perfectly conventional. Furthermore, such details may form the subject of numerous variants according to each particular case of application.

In FIG. 1, as elsewhere in the other figures, may be seen essentially three transporter-belt conveyors following one another so as to make the products travel past a visiometry system according to the invention, between a manufacturing installation and an installation for packaging products whose quality complies, neither of which has been represented. Depicted therein is thus an entrance conveyor 1, or feed conveyor, and an exit conveyor 2, on either side of an intermediate conveyor 3 which constitutes the inspection conveyor proper, causing the products 10 to travel past under a camera for capturing images 4.

The entrance conveyor 1 is illustrated in the form of a parting conveyor, that is to say it breaks down into a series of belts following closed-loop endless belt synchronized paths between two rollers 12 and 13, progressively parting from one another as they pass from the entrance roller 12 to the exit roller 13. In this way, products that are deposited adjoining or substantially so over the width of the conveyor at the entrance of the entrance conveyor are laterally separated and individualized at its exit.

The exit conveyor 2, which is located no longer upstream but downstream of the intermediate conveyor 3, is situated at a slightly lower level than the latter, and it is separated therefrom by a device which plays the role of distributor 5.

This distributor 5 consists of a multitude of plates which, in a normal position, are all parallel side-by-side in the same plane, in an inclined position which guides the products directly from the intermediate conveyor 3 to the exit conveyor 2. The various plates may be controlled individually so as to tilt, as is illustrated for some of them bearing the reference 22 in FIG. 2, about an axis of articulation situated at the level of the upstream roller 23 of the exit conveyor. They then orient themselves upward, thus freeing an empty space of plates, through which the products reaching same fall into a bin of defective products, such as one or other of the bins 25 and 26 visible in FIG. 4.

At the level of the inspection conveyor 3, the figures depict, in addition to the camera for capturing or acquiring images 4 whose field of vision 42 is illustrated by dashed lines, an upper lighting device, illustrated by two symmetric neon tubes 31 and 32, and a lower lighting device 33. The latter is advantageously of the same type as the upper lighting device, and it suffices that it be powered from the same electrical power supply but under a different phase so as to obtain alternating synchronized lighting flashes. Operation of the visiometry system alternately in backlighting mode and in direct lighting mode is ensured through control of the camera 4 in synchronism.

In a manner which is itself conventional, the transporter belt 35 of the intermediate conveyor 3 is a translucent belt. When the image acquired by the camera 4 is a backprojection image captured in backlighting mode by the lower device 33, the corresponding contrast analysis is adjusted so as to be sensitive to the degrees of contrast existing between the luminous background seen through the translucent belt and the opaque zones internal to the contour of the various objects. When the image is taken under the upper lighting, in direct lighting mode, the processing of the signals is adjusted so as to distinguish various gray levels with higher definition, remaining within the limits of what is seen on each product.

With the camera 4 are associated computer means for processing digital image data and which are instructed, according to whether the image data processed are those of an image obtained in backlighting mode for contour analysis, or those of an image obtained in direct lighting mode for surface analysis, respectively in a first step to determine whether a contour of each product detected for degrees of contrast of a first order of magnitude meets predetermined dimensional requirements, and in a second step to determine whether a surface state examined inside a sample zone determined to exhibit a predetermined shape with the help of the dimensional contour data of the first step, meets predetermined surface requirements manifested by degrees of contrast of a second order of magnitude.

The circuit of the transporter belt 35 of the intermediate conveyor passes, like the others, around an upstream roller 36 and a downstream roller 37, but, in addition, around two ancillary rollers 38 and 39, which are movable so as to be parted to a greater or lesser extent in the longitudinal conveying direction. Their relative displacement is placed under the control of signals resulting from the image analysis processing circuit.

When, through these circuits, it is discerned that the contour dimensions noted exhibit a dimensional feature which evidences a mass grouping together several products, the system instructs a parting of the two movable ancillary rollers 38 and 39 which brings about a rearward withdrawal of the downward roller 37, on account of a lengthening of the circuit of the endless belt between the ancillary rollers. Of course, the downstream, roller 37 is itself mounted movably in longitudinal translation at the level of its axis of rotation. Its rearward withdrawal parts the exit of the conveyor from the distributor 5. Hence, all the products reaching the exit of the conveyor at the same moment fall into the bin of defective products.

FIG. 3, which illustrates this situation, presupposes the presence of a single bin of defective products. The situation is the same in the case of FIG. 2, except that, in the latter, the rejection of a defective product is not performed over the entire width of the belt, but only at the level of the plates 22 which have been tilted into a raised position.

In the case of FIGS. 4 and 5, there are two bins for defective products, and the distributor system is supplemented with a flap 27, which is mounted tilting about an axis of articulation provided in the transverse direction of the conveying line between the two. There is just one tilting flap over the conveying width. It is associated with a magnetic annulus 41 which is sensitive to the presence of metallic elements as pollution in the products, be it in their dough or alongside them in parallel. Such metallic elements constitute polluting elements that render the products which contain them unfit for consumption.

The system for detecting metallic pollution is disposed upstream of the visiometry system. It, has priority for instructing the discharging of the products to the bin for polluted products 26. When, it provides a positive response evidencing the presence of metallic pollution, this automatically triggers the tilting of the flap 27 at the desired moment so as to short-circuit the discharging of the noncompliant products which would otherwise take place toward the bin 27, reserved for noncompliant products which are however sound and acceptable as second quality products, or even products intended for animal feed.

FIG. 5 illustrates the fact that, in the case of the machine described, rather than instructing the tilting of all the plates of the distributor 5 at the same time as the tilting of the flap 27, the system instructs a withdrawal of the downstream roller of the conveyor in a similar manner to what is illustrated by FIG. 3.

It goes without saying that, to instruct the tilting of this flap 27, just as to instruct the tilting of the plates of the distributor 5, the instruction command dispatched from the corresponding detection means determines the tilting after a time span which is calculated as a function of the speed of travel of the products, so as to intervene in synchronism with the arrival of the defective or polluted products at the exit of the intermediate conveyor 3.

The foregoing description explains clearly how the invention is practiced in a manner that could not be predicted by the person skilled in the art and how it makers it possible to achieve the objectives that it set for itself. Nevertheless, it emerges from the foregoing that the invention is not limited to the modes of implementation that were specifically described in the course of the examples hereinabove and that on the contrary it extends to any variant involving equivalent means.

Without further elaboration, it is believed that one skilled in the art can, using the preceding description, utilize the present invention to its fullest extent. The following preferred specific embodiments are, therefore, to be construed as merely illustrative, and not limitative of the remainder of the disclosure in any way whatsoever.

In the foregoing and in the following examples, all temperatures are set forth uncorrected in degrees Celsius and, all parts and percentages are by weight, unless otherwise indicated.

The entire disclosure of all applications, patents and publications, cited herein and of corresponding French application No. 0311649, filed Oct. 3, 2003 is incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A quality control inspection process for bakery products, wherein the products to be inspected are deposited in bulk on a transporter belt of an inspection conveyor and made thereby to travel past a visiometry system, under the field of vision of a matrix camera for acquiring digital images associated with means for analyzing the image data thus acquired, said images being captured in a repetitive manner alternating between a backlighting mode for a first step of detection of a contour image for each successive product by analyzing contrasts of a first order in the image data, and a direct lighting mode for a second step of surface analysis of said product inside a sample zone automatically defined so as to be included fully inside said contour of said product, said second step involving analyzing contrasts of a second order in the image data, and wherein a compliant quality attribute is allocated to each individual product for which it has been verified that it meets predetermined geometrical dimension requirements regarding the first step contour image and predetermined surface state requirements regarding the surface state image of said sample zone in the second step.

2. The process of claim 1, wherein the visiometry system is automatically adjusted so as, to be sensitive to degrees of contrast between gray levels of two different orders of magnitude according to whether it is operating in contour detection in the first step or in surface analysis in the second step.

3. The process of claim 2, wherein the alternating lighting in backlighting mode and in direct lighting mode is effected with the help of one and the same electrical power supply.

4. The process of claim 1, comprising calculating from the contour image of each successive product, a length, a width and a sag, checking whether they lie within ranges of predetermined values, and deducting therefrom whether said product complies with said dimension requirements.

5. The process of claim 2, wherein in the second step the degrees of contrast between various gray levels are examined and the density exhibited by blemishes evidencing a predetermined degree of contrast between pixels within said sample zone is determined.

6. The process of claim 1, further comprising, upstream of said visiometry system, submitting said products to a procedure for detecting the presence of polluting elements rendering the products unfit for consumption, and downstream of said visiometry system directing the products for which the presence of said polluting elements has been detected into a specific bin for polluted products.

7. A process as claimed in claim 6, wherein should polluting elements be present, the rejection in terms of polluted products of all the products showing up simultaneously on exit from the visiometry system is instructed and performed automatically.

8. A process as claimed in claim 6, wherein said polluting elements the presence of which should be detected are metallic polluting elements, the detection procedure then being of magnetic type.

9. A process as claimed in claim 1, wherein in the first step of image analysis, said contour image is used to determine whether it exhibits a dimensional feature that evidences the presence of a mass of non-individualized products and wherein if so the rejection in terms of defective products of all the products showing up simultaneously on exit from the visiometry system is instructed and automatically performed.

10. A quality control inspection plant for bakery products, in which said products are deposited on an inspection conveyor which makes them travel past a visiometry system where they are lit alternately in backlighting mode and in, direct lighting mode and where the capture of digital images is carried out, and which comprises means for analyzing said digital images, respectively in a first step to determine whether a contour of each product detected in respect of degrees of contrast of a first order meets predetermined geometrical dimension requirements, and in a second step to determine whether a surface state examined inside a sample zone determined so as to exhibit a predetermined shape fully included within the contour image of the first step, meets predetermined surface requirements manifested through degrees of contrast of a second order, as well as means for automatically instructing, the distributing of the products on exit from said inspection conveyor toward at least one bin for receiving compliant products and one bin for receiving noncompliant products depending upon the results of the image analysis in the first step and in the second step.

11. A plant as claimed in claim 9, comprising an upstream conveyor for feeding said inspection conveyor tending to separate the products from one another at least the longitudinal conveying direction, onto an inspection conveyor which makes them travel past a visiometry system where the capture of the digital images is carried out.

12. A quality control inspection process for bakery products, comprising depositing the products to be inspected on a transporter belt of an inspection conveyor and making them thereby travel past a visiometry system, under the field of vision of a matrix cam era for acquiring digital images associated with means for analyzing the image data thus acquired, controlling said camera to operate in a repetitive manner alternating between a backlighting mode for a first step of said process and a direct lighting mode for a second step of said process, said first and second steps being effective each to view each successive product at least once as complete, analysing the image data acquired according to said first step to determine for each successive product a contour image depending on contrasts of a first order detected, in the image data, calculating a sample zone defined so as to be included fully inside said contour of said product, analysing the image data acquired according to said second step that pertain to said sample zone depending on contrasts of a second order in the image data in said sample zone to determined a surface state of said product, checking whether geometric dimensions calculated from said contour image for each product meets predetermined dimension requirements, allocating a compliant quality attribute to any product meeting sadi dimension requirements, providing that in addition, the surface state in said sample zone for said product meets predetermined surface state requirements, and directing each individual product from said products to be inspected to different specific bins depending on whether it has been allocated said compliant quality or not.

13. The process of claim 12, comprising automatically adjusting the visiometry system to be sensitive to degrees of contrast between gray levels of two different orders of magnitude according to whether it is operating in contour detection in the first step or in surface analysis in the second step, calculating from the contour image of each successive product in said first step, a length, a width and a sag, checking whether they lie, within ranges of predetermined values and deducting therefrom whether said product complies with said dimension requirements, examining in the second step the degrees of contrast between various gray levels and determining the density of such degrees of contrast to detect the presence of blemishes evidencing a predetermined degree of contrast between pixels within said sample zone.
